(19) United States
(12) Patent Application Publication
(10) Pub. No.: US 2007/0178282 A1
(43) Pub. Date: Aug. 2, 2007

(54) Gripping surface having protrusions embedded with soft materials

(75) Inventor: Fred N. Miekka, Arcadia, CA (US)

Correspondence Address: FRANK A. PALASE, SUITE 203, 141 E. HUNTINGTON DRIVE, ARCADIA, CA, 91006, US

(73) Assignee: SIERRA MADRE MARKETING GROUP

(21) Appl. No.: 11/700,932

(22) Filed: Feb. 1, 2007

Related U.S. Application Data
(60) Provisional application No. 60/764,086, filed on Feb. 1, 2006.

(51) Int. Cl. E01F 9/04; B32B 7/02

(52) U.S. Cl. 428/143; 428/217

(57) ABSTRACT

Wear resistant gripping surfaces are disclosed having a high friction material embedded between protrusions of a harder material. The protrusions may be of the same material or may even be part of the base substrate. The resulting surfaces have high friction properties and exhibit good wear resistance. The high friction material may consist of rubber or other relatively soft substances. Applications include the running boards of sport utility vehicles and trucks, non-slip pads for stairs and walkways, and pads for pedals such as brakes.

### CROSS-REFERENCE TO RELATED APPLICATIONS

This non-provisional application claims benefit of the provisional application filed on Feb. 1, 2006 having application number U.S. 60/764,086.

### BACKGROUND OF THE INVENTION

1. Field of the Invention

This invention relates to gripping surfaces and more particularly to surfaces having soft high friction materials such as rubber embedded into hard wear resistant surfaces.

2. Description of the Related Art

There are numerous methods that may be employed to improve coefficient of friction. For example, a rubber coating may be applied to certain substrates. A good example of this is the use of rubber pads on the surface of brake pedals in vehicles. Rubber is somewhat soft and may deform under pressure. Deformation often improves grip. Generally speaking, the softer the rubber the greater the improvement in grip. Unfortunately the softer the surface the faster it tends to wear. In addition, a soft surface may tend to deform to an undesirable extent.

Another approach involves increasing the surface roughness of a given substrate. Increasing surface roughness may provide points of interlocking when pressure is applied. In addition, increasing roughness may also increase surface pressure by reducing available area. This approach is often employed to improve grip of knobs and the like used for turning by hand. While providing a durable non-slip surface, such surfaces may not be best suited for each and every application. For example, the gas pedals of many racing cars have a rough metal non slip surface. The high coefficient of friction that results may be attributed in part to the deformity of the sole of the footwear worn by the driver. Drivers wearing hard soles will obtain a minimal benefit from these non-slip surfaces.

Another approach is to combine the attributes if a soft material with surface roughness. A pattern of roughness on a rubber surface is often employed. Unfortunately while providing good gripping properties, such surfaces are often prone to premature wear from repeated use.

Non slip additives may be embedded into a given surface to increase the coefficient of friction thereby improving grip. Non-slip coatings may also be used to improve grip.

The above examples outline several common ways of providing gripping non-slip surfaces having a high coefficient of friction.

Despite these options, there is a need to provide a low cost gripping non-slip surface having a high coefficient of friction to numerous other surfaces and which has little tendency toward wear.

It is an object of this invention to provide a non-slip surface having a high coefficient of friction.

It is a further object of this invention to provide a non-slip surface having a high coefficient of friction to a wide variety of other surfaces.

It is a further object of this invention to provide a non slip-surface having little tendency toward wear.

Finally, it is an object of this invention to provide a non-slip surface at low cost.

### SUMMARY OF THE INVENTION

This invention therefore proposes non-slip surfaces consisting of multiple protrusions of a hard material with a softer high coefficient of friction material filling in the voids between the protrusions. The resulting non-slip surfaces exhibit good high friction properties toward a wide variety of surfaces and have a low tendency toward wear.

### BRIEF DESCRIPTION OF THE DRAWINGS

FIG. 1 shows a surface having numerous protrusions.

FIG. 2 shows a non-slip gripping surface consisting of numerous protrusions of a hard material with softer material filling in the voids between them.

FIG. 3 shows a set of two steps having a non-slip gripping surface of the present invention.

FIG. 4 shows a round gripping surface of the present invention.

FIG. 5 shows a cross sectional view of a soft high friction material filling in voids between surface protrusions of a harder material.

FIG. 6 shows a cross sectional view of a soft high friction material filling in voids between surface protrusions of a harder material having flattened tops.

FIG. 7 shows a soft high friction material filling in voids between surface protrusions of a harder material having flattened tops.

### DESCRIPTION OF THE INVENTION

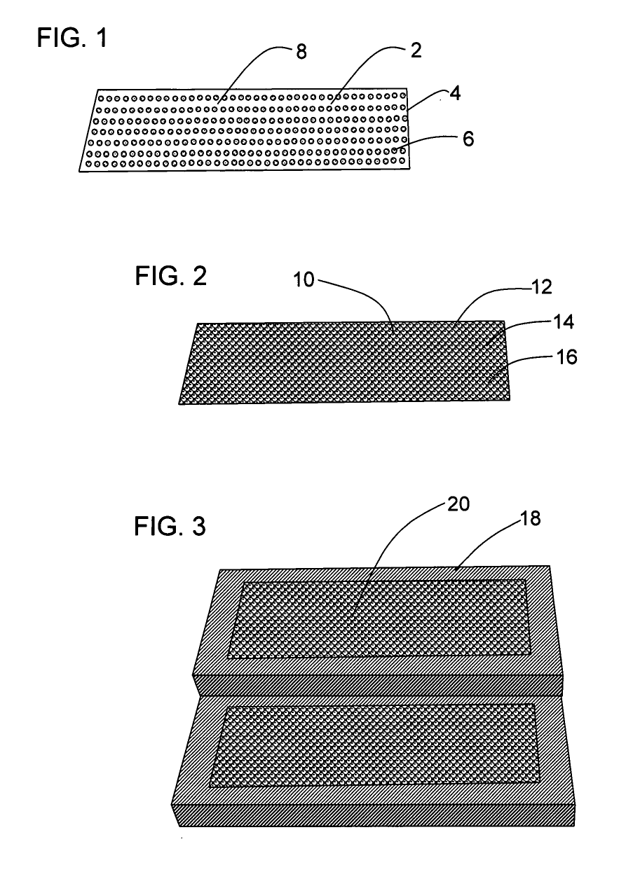

FIG. 1 shows a surface having numerous protrusions. Surface 2 is shown having substrate base portion 4 along with numerous protrusions 6. This particular substrate is suitable for making wear resistant non-slip gripping surfaces by filling in voids 8 between protrusions 6 with a material of the correct softness and coefficient of friction. The softness of the material may depend on the intended application.

FIG. 2 shows a non-slip gripping surface consisting of numerous protrusions of a hard material with softer material filling in the voids between them. Non-slip gripping surface 10 is composed of numerous protrusions 12 of a hard material and has a softer material 14 filling in void space 16 between hard material protrusions 12.

FIG. 3 shows a set of two stairs having a non-slip gripping surface of the present invention. Stairs 18 are shown having applied gripping surfaces 20 to provide non-slip properties and improve grip.

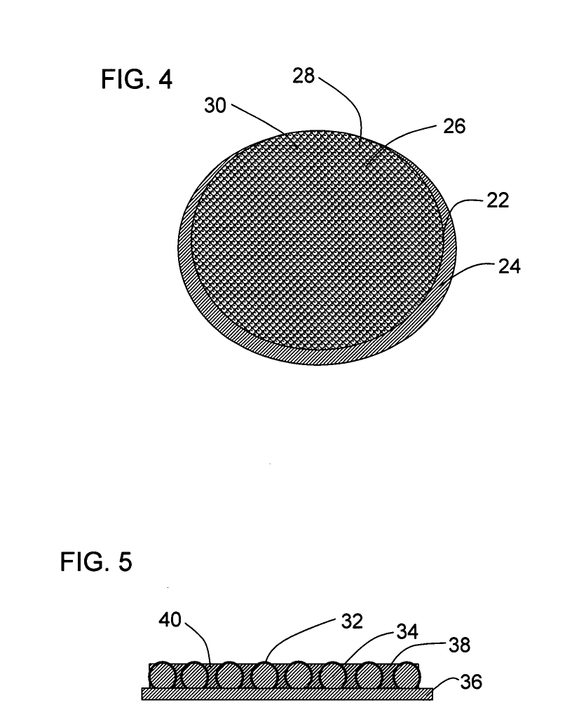

FIG. 4 shows a round gripping surface of the present invention. Gripping surface 22 consists of base portion 24 having numerous protrusions 26 of a hard material. Also shown is softer material 28 located in voids 30 between protrusions 26.

FIG. 5 shows a cross sectional view of a soft high friction material filling in voids between surface protrusions of a harder material. Gripping surface 32 consists of hard material surface protrusions 34 attached to base portion 36. Also shown is softer material 38 located within voids 40 between hard material surface protrusions 34.

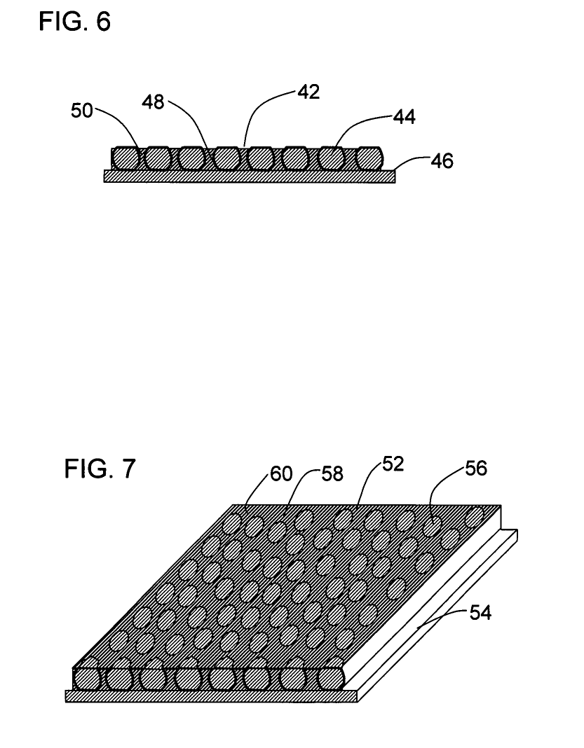

FIG. 6 shows a cross sectional view of a soft high friction material filling in voids between surface protrusions of a harder material having flattened tops. Gripping surface 42 consists of hard material surface protrusions 44 having flattened tops attached to base portion 46. Also shown is softer material 48 located within voids 50 between hard material surface protrusions 44.

The flat tops of hard protrusions may be used to provide a smoother top surface, Alternatively, controlling the flatness of the protrusion tops themselves may provide a way of controlling overall properties.

FIG. 7 shows a soft high friction material filling in voids between surface protrusions of a harder material having flattened tops. Gripping surface 52 consists of base portion 54 having flat top protrusions 56 of a hard material and softer material 58 filling in voids 60 between flat top protrusions 56.

Those skilled in the art will understand that the preceding exemplary embodiments of the present invention provide foundation for numerous alternatives and modifications. These other modifications are also within the scope of the limiting technology of the present invention. Accordingly, the present invention is not limited to that precisely shown and described herein but only to that outlined in the appended claims.

What is claimed is:

1. A gripping surface assembly comprising:
a bottom solid portion, and a gripping agent;
said bottom solid portion having a top surface;
said top surface of said bottom solid portion having a plurality of protrusions extending from said top surface in an outward direction forming one or more cavities;
and;
said plurality of protrusions extending in an outward direction from said top surface of said bottom solid portion being comprised of a material having a greater hardness than said gripping agent;
and;
said gripping agent dispersed within said cavities of said top surface of said bottom solid portion thereby providing gripping properties to other surfaces.
